(19) United States
(12) Patent Application Publication
(10) Pub. No.: US 2011/0206830 A1
(43) Pub. Date: Aug. 25, 2011

(54) REVERSE INTERFEROMETRIC METHOD AND APPARATUS FOR MEASURING LAYER THICKNESS

(75) Inventors: Arun Kumar, Ann Arbor, MI (US); William Thomas Sommerville, Clarkston, MI (US)

(73) Assignee: United Solar Ovonic LLC, Auburn Hills, MI (US)

(21) Appl. No.: 12/709,077

(22) Filed: Feb. 19, 2010

(51) Int. Cl. B05D 5/12; G01J 3/46; G01J 3/28

(52) U.S. Cl. 427/10; 356/402; 356/51

(57) ABSTRACT

A reverse interferometric method for the determination of the thickness of a layer of material employs a multi-wavelength light source which generates a light beam which comprises a time-variant series of different monochromatic wavelengths. The beam is reflected from the body of material being measured and is detected by a broad spectrum wavelength detector which produces a signal comprising a series of data points indicating the reflectivity of the sample as a function of the time-variant series of monochromatic wavelengths. A signal processor processes these data points to fit them to a model waveform, and the frequency of the model waveform is used to calculate the thickness of the body of material. Further disclosed are apparatus for carrying out the method and use of the method in a continuous process for the fabrication of thin film materials.

### FIELD OF THE INVENTION

This invention relates to the monitoring of the thickness of layers of thin film materials. More specifically the invention relates to optical methods for monitoring thickness. Most specifically the invention relates to a reverse interferometric method and apparatus for monitoring layer thickness of thin film materials.

### BACKGROUND OF THE INVENTION

Accurate measurements of the thickness of thin film layers such as semiconductor materials, optical coatings, protective coatings, and the like are often very important in connection with the manufacture, testing and use of semiconductor devices, optical devices, opto-electronic devices, and the like. For example, semiconductor devices such as photovoltaic devices, display devices, and the like frequently include large area layers of thin film materials, and it is necessary to maintain precise control of the thickness of such layers so as to optimize device performance and production yield. Furthermore, production techniques and apparatus have been developed which allow for the high speed, high volume manufacture of such devices in a continuous process; and there is a corresponding need for rapid, in-line systems for the real-time monitoring of layer thicknesses in such processes.

Heretofore, thickness measurements of optical and electronic thin films have preferably been obtained utilizing an interferometric process in which broad spectrum (“white”) illumination is impinged upon a layer. The wave nature of the light, in conjunction with the optical properties of the thin film layer, produces an interference pattern comprising a periodic, wavelength dependent, variation in reflectivity, and one such typical pattern is shown in FIG. 1. The pattern is manifest as a periodic wave corresponding to maxima and minima of a continuum of the constituent wavelengths of the incident white light reflected from the thin film. Based upon the frequency of the wave pattern, and the refractive index of the film, one of ordinary skill in the art can compute the thickness of the layer which produced the interference pattern. In prior art methods the wavelength and intensity of the reflected light at each constituent wavelength is determined through the use of a wavelength responsive detector, such as a spectrophotometer, which breaks the reflected white light into its constituent wavelengths and analyzes the intensity of the reflected light as a function of these wavelengths.

Prior art systems rely upon the use of a spectrophotometer; consequently, they are inherently expensive to install and operate. These cost factors have limited their use as process monitoring devices in high volume, large scale applications. This expense and difficulty in operating prior art interferometric systems has created a long-felt need for a simple, inexpensive, and reliable system and method for measuring film thickness suitable for use during the manufacturing process. As will be explained hereinbelow, the present invention provides a novel reverse interferometric method and apparatus for accurately carrying out measurements of thin film thicknesses. The optical system of the present invention employs simple components and does not require the use of any spectrophotometer or other spectral analyzer. Consequently, the cost of systems of the present invention is at least an order of magnitude less than that of prior art systems. This fact allows for the incorporation of measurement systems of the present invention directly into processing equipment enabling real-time monitoring and controlling of deposition systems, coating systems, and the like. These and other advantages of the invention will be apparent from the drawings, discussion, and description which follow.

### SUMMARY OF THE INVENTION

Disclosed is a reverse interferometric method for determining the thickness of a layer of a material. According to the method, there is provided a multi-wavelength light source which includes a plurality of light emitters, such as light emitting diodes, which are understood to also include laser diodes. Each light emitter is operative to emit a beam of essentially monochromatic light of a preselected wavelength. The wavelengths of light emitted by the members of the plurality of light emitters differ from one another so as to define a preselected wavelength range. A layer of material which is to have its thickness measured is disposed so that it will be illuminated by the beams of essentially monochromatic light. The members of the plurality of light emitters are then sequentially energized so as to sequentially illuminate the layer with a time-variant series of incident beams of differing wavelengths of essentially monochromatic light. The incident beams are reflected from the layer so as to produce a time-variant series of reflected beams. A light detector is disposed so as to sense light reflected from the layers. The detector is activated so as to allow it to sense the time-variant series of reflected beams and generate a signal corresponding thereto. This signal is processed so as to generate a waveform which corresponds to the reflectance of light from the layer of thin film material as a function of the wavelengths of light in said preselected wavelength range. This waveform may be processed in accord with methods known in the art to determine the thickness of the layer.

In particular embodiments, the multi-wavelength light source is configured so that its constituent light emitters are radially distributed thereupon so as to be equally spaced from said layer. In particular embodiments, the light source includes at least ten, and in further embodiments at least twenty, light emitters. In some instances, the preselected wavelength range is 400-900 nanometers.

In some other embodiments, the different sources of light can also be modulated in the frequency domain so that all wavelengths can be present at the same time but varying in intensity at different frequencies. This allows a single detector to see the contribution of each component simultaneously, something that can be invaluable when the material of interest is moving at high speeds. Also, the different sources of light can also be separated physically from each other with each source having an associated detector. If the speed of the material passing by is known, then the light sources can be pulsed in such a way that they all illuminate the same area at different times and from the same angle of incidence. Further, these sources can operated with the light signal modulated at different frequencies in order to electronically eliminate cross talk between closely spaced detectors and light sources. If wavelength specific light sources are used, then identical wavelength specific detectors can also be used to eliminate cross talk. An example of this would be to use pairs of identical light emitting diodes where one converts current to light and the other converts the reflected light back to current.

Processing the signal from the detector may comprise the use of a curve fitting method to fit data points corresponding to the intensity of the reflected beams to a waveform corresponding to a model interferometric pattern for the reflection of white light from a layer of material. Processing of the signal may be accomplished through the use of a Levenberg-Marquardt algorithm.

The method of the present invention may be used to control one or more steps in a production process in response to the determined thickness of the layer.

Further disclosed are systems which are operative to carry out the method of the present invention.

The method and apparatus of the present invention may be implemented in a continuous process for the deposition of a layer of thin film material onto a substrate which is continuously advanced through a deposition station wherein the layer is deposited thereupon. Such processes may be used in connection with the continuous deposition of large area, thin film photovoltaic materials.

### BRIEF DESCRIPTION OF THE DRAWINGS

FIG. 1 is an interferometric pattern as generated using prior art techniques and comprising a waveform depicting the reflectivity of a layer of thin film material with regard to a continuum of constituent wavelengths of a beam of white light as reflected from a thin film layer;

FIG. 2 is a schematic depiction of a system used to implement the reverse interferometric method of the present invention;

FIG. 3 is a depiction of a waveform derived in accord with the present invention, and further showing the discrete data points used to derive that waveform;

FIG. 4 is a depiction of a portion of a light source which may be utilized in the present invention;

FIG. 5 is a schematic diagram of a circuit used to control a light emitting diode in accord with the present invention; and

FIG. 6 is a schematic depiction of another embodiment of the present invention as implemented in connection with a moving substrate web.

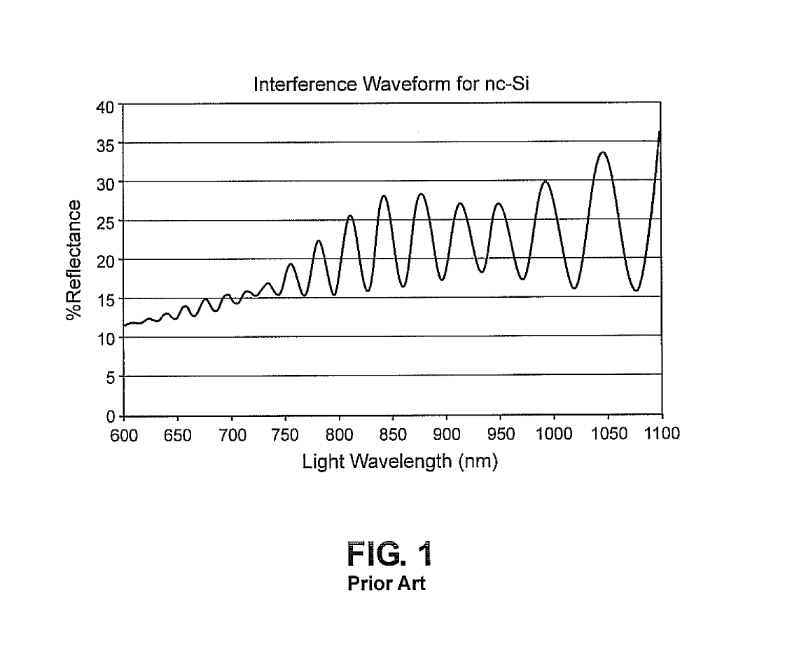

### DETAILED DESCRIPTION OF THE PREFERRED EMBODIMENTS

The present invention constitutes a reverse interferometric method which may be used for determining the thickness of a layer of thin film material. The method of the present invention is referred to as a reverse interferometric method since, unlike conventionally employed interferometric methods, it does not reflect a beam of broad spectrum (white) illumination from a sample and subsequently analyze the reflected beam through the use of a spectrophotometer or other such wavelength dispersing detector. Instead, the method of the present invention impinges a thin film sample with a time-variant series of beams of essentially monochromatic light and then utilizes a general purpose, non-spectrophotometric, detector system to detect the reflectivity of the sample of thin film material with regard to each of the essentially monochromatic beams. The use of essentially monochromatic light emitters eliminates the need for a complicating wavelength dispersive element such as a diffraction grating or movable slit, a filter, or a beam splitter. The essentially monochromatic beams of light are distributed over a wavelength range, and the detector provides a series of data points corresponding to the reflectivity of the material with regard to each of the monochromatic beams. This data constitutes a signal which is processed in accord with the present invention utilizing curve fitting methods so as to generate a waveform which for all practical purposes is essentially the same as a waveform which would have been measured in a conventional interferometric method carried out utilizing a spectrophotometer or other such frequency analyzing detection system. The reverse interferometric method and apparatus of the present invention is much simpler in construction than are conventional interferometric systems; hence, systems of the present invention are relatively low in cost, inherently reliable, and simple to operate.

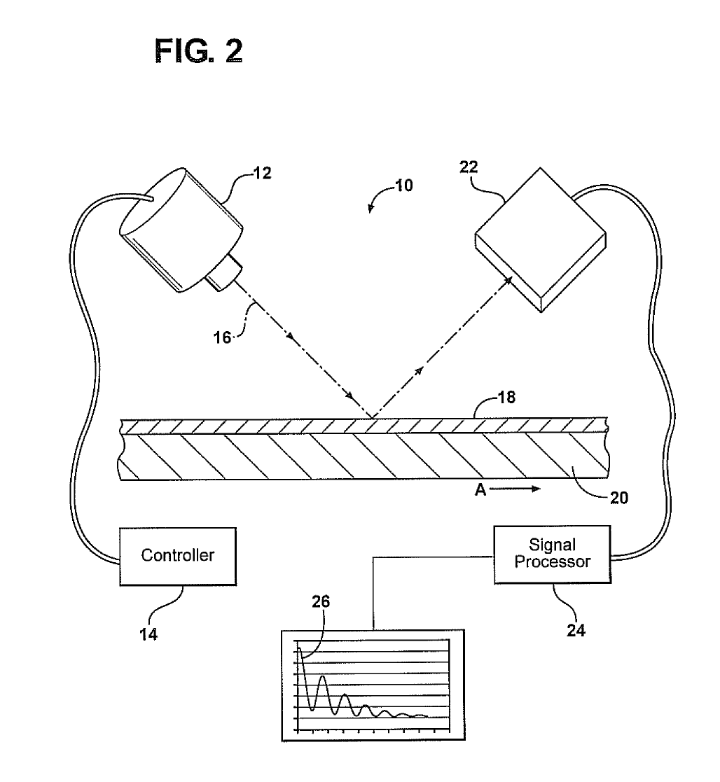

Referring now to FIG. 2, there is shown a schematic depiction of a generalized reverse interferometric system 10 as implemented for the practice of the present invention. The system of FIG. 2 includes a multi-wavelength light source 12 which includes a plurality of discrete light emitters therein. Each of the light emitters is operative to emit a beam of essentially monochromatic light of a preselected wavelength without the need of any filters or other such optical elements. In specific embodiments of the present invention, the light emitters are light emitting diodes, although other sources of essentially monochromatic light such as lasers, including solid state lasers, may be utilized. In the context of this disclosure, the light sources are described as emitting “essentially monochromatic light”. This language is chosen to reflect the fact that even nominally monochromatic light sources such as lasers and light emitting diodes do, as a result of quantum effects, material limitations, and limitations of construction, emit light having a small, but finite, bandwidth. A typical light emitting diode provides an output distribution comprising a sharp peak in which at least 80% of the illumination is concentrated in a narrow wavelength range (typically no more than 30 nm). In contrast, the spectrum of filtered light is characterized by a broader intensity distribution. Hence, the light sources utilized herein are interchangeably described as being “monochromatic” or “essentially monochromatic”. This nomenclature is meant to differentiate the light sources used in the present invention from broad spectrum light sources as well as from narrower bandwidth sources such as filtered light sources which, while limited to portions of a continuous spectrum, do not have a sharp intensity distribution and as such are not understood to be “essentially monochromatic”.

As further shown in FIG. 2, the multi-wavelength light source is in communication with a controller 14 which is operative to sequentially energize the various light emitters of the light source 12 so as to cause it to emit illumination 16 which constitutes by a time-variant series of essentially monochromatic beams of light. The invention has the advantage of optionally employing no moving parts. The illumination 16 is directed onto a layer of thin film material 18 which is shown as being supported upon a substrate 20. In the FIG. 2 embodiment, the substrate 20 and associated thin film layer 18 are shown as continuously advancing along a path of travel indicated by arrow A, and as such are representative of implementations of the present system in connection with continuous processes for the deposition of thin film optical and/or semiconductor layers.

In the depiction of FIG. 2, the beam 16 is reflected from the thin film layer 18 so as to produce a reflected beam which in turn is sensed by a detector 22. It is a notable feature of the present invention that the detector 22 is a relatively low-cost photodetector which need not include any particular wavelength dispersing and/or discriminating systems. As such, the detector 22 does not include a spectrophotometer or any other type of wavelength-dispersing device. There are a variety of light sensors which may be used in the present invention, and one specific sensor which may be employed for this purpose is a TSL230ARD light to frequency converter sold by the Texas Advanced Optoelectronic Solutions (TAOS) corporation. Other specific detectors that can be utilized include the TPS852 analog light sensor sold by the Toshiba corporation, PDV-P9001 photocell sold by Advanced Photonix Incorporated, SFH 2430-Z photodiode sold by OSRAM Opto Semiconductor Incorporated, TEMD6010FX01 ambient light sensor sold by Vishay corporation, or QSE122 phototransistor sold by Fairchild Semiconductor corporation. Other similar types of detector will be readily apparent to those of skill in the art. Also, while FIG. 2 shows a photodetector system which includes a single photosensor, it is to be understood that in other embodiments of the invention, detection of reflected light may be accomplished through the use of several photosensors. Therefore, as used herein the terms “photodetector” or “detector” are understood to include any non-dispersive detector system based upon one or more light-sensitive elements.

The detector 22 receives a series of time-variant, reflected, beams of essentially monochromatic light from the thin film layer 18. In accord with well understood optical principles, the intensity of the various reflected beams will vary as a function of their wavelengths owing to constructive and destructive interference conditions established as a function of wavelength, refractive index of the thin film material, and thickness of the thin film material.

The detector 22 generates a signal constituting a string of data points corresponding to the reflectivity of the layer 18 with regard to the series of beams of essentially monochromatic light. This signal is communicated to a signal processor 24 which may comprise a programmed general-purpose computer or, in some embodiments, a dedicated data processor. The signal processor 24 receives the signal from the sensor 22 and processes it so as to generate a waveform 26 which corresponds to the reflectance of light by the layer of material 18 over a wavelength range which encompasses the wavelengths of light emitted by the multi-wavelength light source 12. This waveform will correspond to a like waveform which would have been produced utilizing a prior art interferometric method relying upon analysis of broadband reflected illumination utilizing a wavelength responsive detection system such as a spectrophotometer-based system. This waveform 26 may be generated by the processor 24 through the use of processing software and algorithms which fit the data points generated by the detector 22 to a model waveform pattern as described above. Such pattern generation can be accomplished through the use of curve fitting techniques and software known to those of skill in the art and may be variously implemented. In some specific instances, the processor 24 utilizes a Levenberg-Marquardt algorithm to find a best fit between the data points and a model reflection pattern. One such Levenberg-Marquardt algorithm is based upon the formula below:

$$D \cdot {e}^{\frac{- {k}^{2}}{c}} \cdot sin \frac{4 π k ( \frac{{n}_{λ}}{{n}_{11}} )}{A} + B π + E \cdot {e}^{\frac{- {k}^{2}}{F}} + G$$

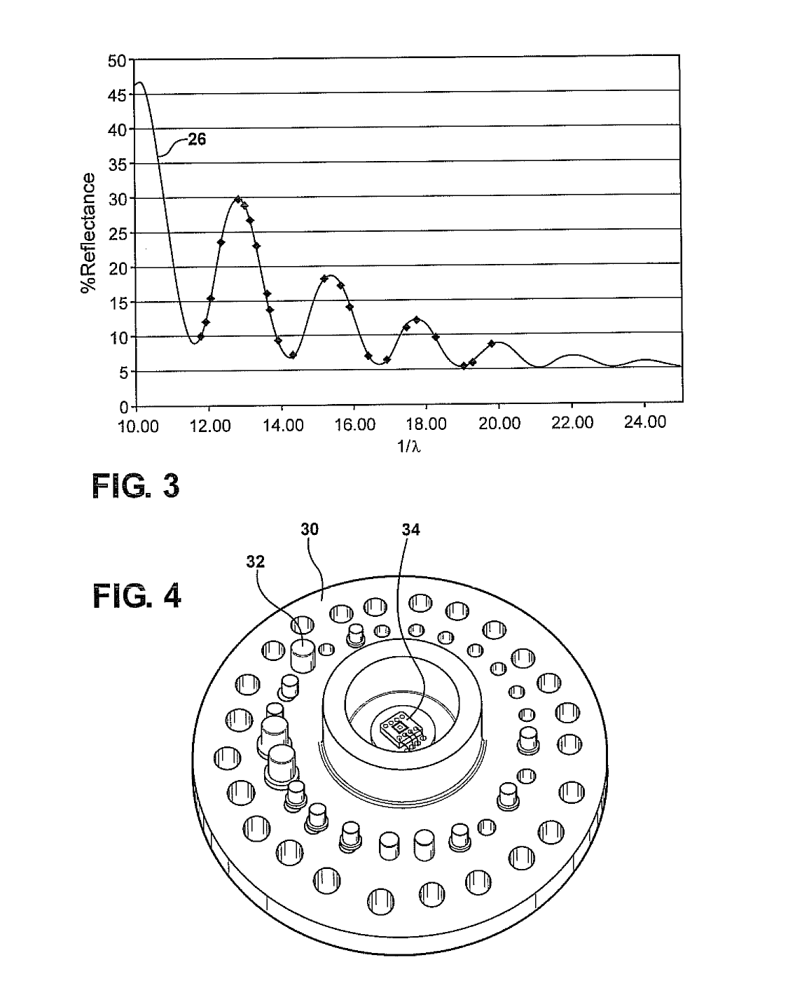

Referring now to FIG. 3, there is shown a detailed depiction of the waveform 26 generated by the present invention. As is shown therein, the waveform represents a graph showing the percent reflectance of light as a function of the inverse of the wavelength of that light. Also shown in the FIG. 3 waveform are the individual data points used to generate the waveform curve. As will be seen, the data points very closely fit an idealized interference pattern. As is well known to those of skill in the art, one can readily calculate the thickness of the reflecting layer based upon the periodicity of the waveform 26 and the index of refraction of the reflecting layer.

Thickness data generated utilizing the method and apparatus of the present invention can be used to control parameters of a deposition process. Given that the optical system of the present invention is simple and low in cost, the system of the present invention may be readily disposed as an integral part of thin film deposition chambers. For example, one or more systems of the present invention may be disposed within deposition chambers used to prepare thin film optical and/or semiconductor layers, so as to measure the thicknesses of layers as they are being deposited and/or following their deposition. The low cost and simplicity of the system allows for incorporation of a number of thickness measuring stations within a particular deposition apparatus. For example, systems of the present invention may be arrayed so as to sequentially measure the thickness of depositing layers. Likewise, the systems may be disposed in parallel so as to simultaneously measure thickness of layers at a number of locations spaced across the width of a body of deposited material. The availability of low cost, simple thickness monitoring stations will greatly improve the quality and yield of deposition processes, particularly continuous deposition processes.

The system of the present invention may be implemented in a variety of configurations in view of the teaching presented herein. In some specific instances, the light source may, as discussed above, comprise a plurality of light emitting diodes disposed within a single housing. In some particular embodiments, the diodes are disposed so as to be distributed in a spatial arrangement which places them in approximately equal distance and angular relationships with the layer of material which is being illuminated by the multi-wavelength source. In this regard, in one particular embodiment, the individual light emitting diodes are radially disposed within the light source. Referring now to FIG. 4, there is shown a portion of a light source comprising a support plate 30 having a plurality of openings defined therein. The openings are all radially disposed in two concentric rows relative to the center of the plate. As depicted in FIG. 4, a number of photodiodes, as represented for example by diode 32, are disposed in the innermost row of openings. In FIG. 4, 14 diodes are shown as being disposed in the openings. In yet other embodiments, a larger or smaller number of diodes may be employed. In order to provide a sufficient number of data points to generate an accurate curve, the light source will typically include at least 10 light emitting diodes each producing a different wavelength of monochromatic light. In some specific embodiments, at least 20 diodes will be utilized, and in one particular embodiment as used to generate the curve of FIG. 3, 22 light emitting diodes were utilized.

In the drawing of FIG. 4, it will be seen that the center portion of the plate includes a housing segment which contains various of the circuitry used to control the activation of the diodes. It will be understood that that back side of the plate (not shown) supports electrical connections to the diodes.

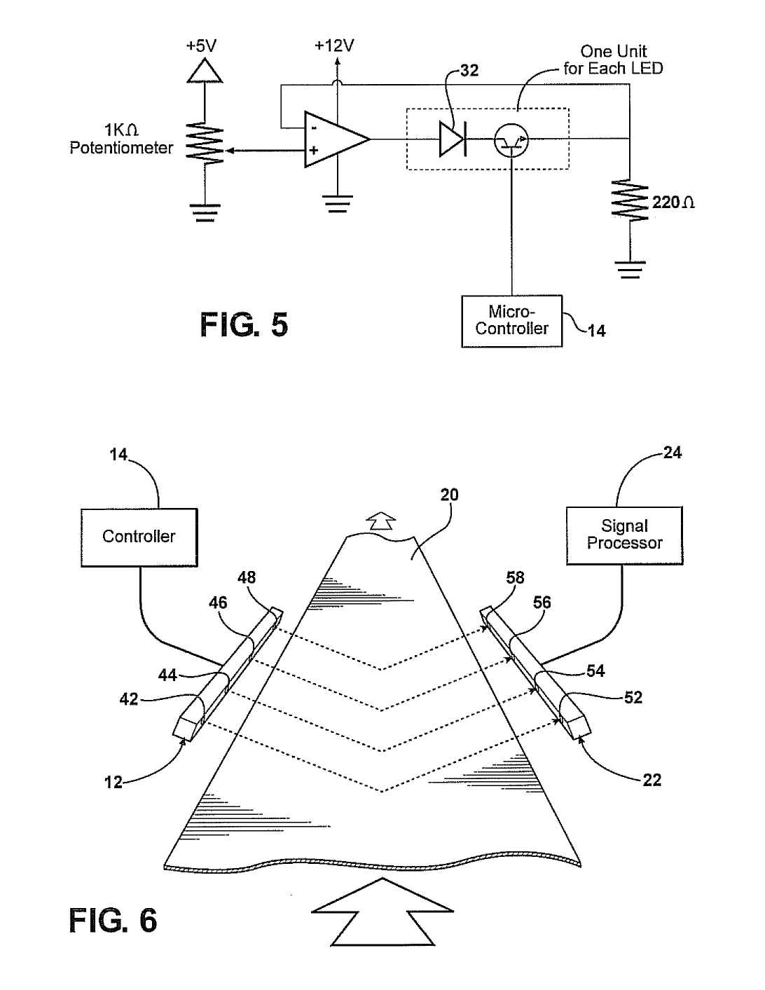

Activation of the diodes may be via control circuitry operated in connection with a microcontroller which sequentially illuminates each of the diodes for a predetermined period of time. Referring now to FIG. 5, there is shown one typical control circuit used for this purpose. As shown therein, the control circuit operates in connection with a microcontroller and includes a plurality of subunits corresponding to the number of specific diodes employed. Other embodiments of such circuitry will be readily apparent to those skilled in the art.

Yet other embodiments of the present invention may be implemented. For example, while the foregoing discussion concerned a system in which the light source was activated to sequentially direct essentially monochromatic beams of illumination onto the sample being measured, in some embodiments illumination and detection at multiple wavelengths may be accomplished simultaneously. In this regard, each of the individual light sources may be modulated at a different frequency, and illumination from each of the sources directed, simultaneously, onto the sample. The detector will produce an output signal which is indicative of the plurality of different beams of essentially monochromatic light, and this detector signal will also contain information regarding the modulation of each of the beams. In this embodiment, the detector signal will be analyzed using frequency domain analysis to determine the reflectivity at each of the wavelengths, and this information will be used in the manner described above to generate the waveform as described above.

Another embodiment of the present invention in which simultaneous impingement of the beams is employed may be implemented utilizing the fact that a light emitting diode which is operative to emit a particular wavelength of light will also function as a detector for detecting that same wavelength of light. In this particular embodiment of the present invention, the detector portion of the apparatus will include a number of light emitting diodes functioning as photosensors. Each diode will correspond to one of the light emitting diodes in the light source. In this manner, the detector will be responsive to the individual wavelength, although it will not be required to include any wavelength dispersive or other separate optical elements.

Referring now to FIG. 6, there is shown yet another embodiment of the present invention as operative to measure thickness of a layer of material disposed upon a moving substrate web 20. In this embodiment, the light source 12 includes a plurality of light emitters 42, 44, 46, 48 disposed in a linear array positioned along the length of the moving substrate 20. For purposes of illustration, four light emitters 42-48 are shown, although it is to be understood that the number may be otherwise varied. These light emitters are positioned so as to illuminate a particular portion of the substrate web 20 as it passes there past.

The system of FIG. 6 includes a photodetector 22, which in this instance includes a plurality of separate photosensors 52, 54, 56 and 58 corresponding in number to the light emitters 42-48. As in the FIG. 2 embodiment, the light source 12 is in communication with a controller 14 and the detector 22 is in communication with a signal processor.

As shown in FIG. 6, the light source 12 is positioned so as to illuminate longitudinally spaced apart portions of the substrate web 20, and the detector 22 is positioned so as to receive light reflected from such longitudinally spaced apart positions. The operation of the FIG. 6 system is synchronized with the speed of substrate web travel, and in this manner each pair of light emitters and light sensors may collect data from a particular point on the substrate web as it passes there past. For example, light emitter 42 and associated detector 52 will measure a specific location on the web 20 as it passes there past. As the web 20 advances further along its path of travel, light source 44 and associated detector 54 will remeasure that same spot at a different wavelength. Thereafter, succeeding pairs will take further measurements on that same spot. There are several modes in which the synchronization may be maintained. For example, the controller 14 may sequence the illumination of the light emitter so as to illuminate the particular chosen spot as it passes there past. In this mode, the detectors will operate on a continuous basis and will provide an output signal when a reflected beam strikes them. In this manner, the detector 22 will generate a time-variant signal which is processed by the signal processor 24 as described above. In an alternative mode of operation, the light sources may operate on a continuous basis, and the detector operation may be synchronized with web travel so as to periodically sample the reflected beam so as to measure the selected spot as it passes there, past. This detector synchronization may be accomplished by specifically activating each detector in a time sequence. Alternatively, the detector operation may be synchronized by operating the detectors on a continuous basis and time sampling their output signals. All of such embodiments may be readily implemented through control circuitry associated with the signal processor or other portions of the system. In yet a further embodiment of this system, frequency modulation of the light sources and detectors may be utilized as previously described so as to eliminate any possible cross talk between the various detectors.

While the foregoing system has been described primarily with regard to its use over a range of visible frequencies, the principles of the present invention may be implemented utilizing different or broader frequency ranges. For example, the system may be configured to operate in the ultraviolet portion of the spectrum, the visible portion of the spectrum, and the infrared portion of the spectrum, either singly or in combination. In such instances, appropriate light sources and detectors will be readily apparent to one of skill in the art. It should also be noted that in some instances a number of separate light sources and/or photosensors may be required to cover the full range of wavelengths being utilized.

In the operation of the various embodiments of the invention, the apparatus is first calibrated by disposing a highly reflective surface, such as a body of white paper or mirror, in the light beam and cycling each of the light emitters so as to generate a 100% reflectance signal for each of the wavelengths. Following calibration of the apparatus, the sample to be measured is disposed in the beam, and each of the light sources is cycled individually. The detector measures the reflectance at each of the wavelengths, and its output constitutes the data points generated by the detector. As described above, this data is analyzed so as to generate the waveform; and based upon the frequency of this waveform, thickness is readily determined.

The foregoing describes some specific embodiments of the present invention but is not meant to be a limitation upon the practice thereof. Other modifications, embodiments, and variations will be readily apparent to those of skill in the art in view of the teaching presented herein. It is the following claims, including all equivalents, which define the scope of the invention.

1. A reverse interferometric method for determining the thickness of a layer of a material, said method comprising:
providing a multi-wavelength light source, said light source including a plurality of light emitters, each light emitter being operative to emit a beam of essentially monochromatic light of a preselected wavelength, wherein the preselected wavelengths of light emitted by the members of said plurality of light emitters differ from one another so as to define a preselected wavelength range;
disposing a layer of a material so that it will be illuminated by the beams of essentially monochromatic light emitted by the plurality of light emitters;
sequentially energizing the members of the plurality of light emitters so as to sequentially illuminate the layer with a time-variant series of incident beams of differing wavelengths of essentially monochromatic light, whereby said incident beams are reflected from said layer so as to produce a time-variant series of reflected beams;
disposing a light detector so as to sense light reflected from said layer;
activating said detector so as to sense said time-variant series of reflected beams and generate a signal corresponding thereto;
processing said signal so as to generate a waveform corresponding to the reflectance of light from said layer as a function of the wavelengths of light in said preselected wavelength range; and
processing said waveform so as to determine the thickness of said layer.

2. The method of claim 1, wherein said light emitters comprise light emitting diodes.

3. The method of claim 1, wherein said multi-wavelength light source is configured so that said light emitters are radially distributed thereupon so as to be equally spaced from said layer.

4. The method of claim 1, wherein said plurality of light emitters comprises at least ten light emitters.

5. The method of claim 1, wherein said plurality of light emitters comprises at least twenty light emitters.

6. The method of claim 1, wherein said preselected wavelength range is 400-900 nanometers.

7. The method of claim 1, wherein the step of processing said signal from said detector comprises uses a curve fitting method to fit data points corresponding to the intensity of said reflected beams to a waveform corresponding to a model interferometric pattern for the reflection of white light from a layer of material.

8. The method of claim 1, wherein the step of processing said signal from said detector comprises the use of a Levenberg-Marquardt algorithm.

9. The method of claim 1, including the further step of controlling a step in a production process in response to the determined thickness of said layer.

10. In a continuous process for the deposition of a layer of a thin film material onto a substrate which is continuously advanced through a deposition station wherein said layer is deposited thereupon, the improvement comprising:
monitoring the thickness of said layer of material while it is being deposited in said deposition station and/or after it has been deposited, through the use of a reverse interferometric method comprising the steps of:
providing a multi-wavelength light source, said light source including a plurality of light emitters, each light emitter being operative to emit a beam of essentially monochromatic light of a preselected wavelength, wherein the preselected wavelengths of light emitted by the members of said plurality of light emitters differ from one another so as to define a preselected wavelength range;
disposing said layer of material so that it will be illuminated by the beams of essentially monochromatic light emitted by the plurality of light emitters, while it is being deposited and/or after it is deposited;
sequentially energizing the members of the plurality of light emitters so as to sequentially illuminate the layer while it is being deposited and/or after it is deposited, with a time-variant series of incident beams of differing wavelengths of essentially monochromatic light, whereby said incident beams are reflected from said layer so as to produce a time-variant series of reflected beams;
disposing a light detector so as to sense light reflected from said layer;
activating said detector so as to sense said time-variant series of reflected beams and generate a signal corresponding thereto;
processing said signal so as to generate a waveform corresponding to the reflectance of light from said layer as a function of the wavelengths of light in said preselected wavelength range; and
processing said waveform so as to determine the thickness of said layer.

11. The method of claim 10 including the further step of controlling a parameter of the deposition process in response to the determined thickness of said layer.

12. The method of claim 10, wherein said process is a process for the deposition of a layer of a transparent conductive oxide material.

13. The method of claim 10, wherein said process is a process for the fabrication of a thin film photovoltaic device.

14. A reverse interferometric apparatus for determining the thickness of a layer of a material, said apparatus comprising:
a multi-wavelength light source including a plurality of light emitters, each light emitter being operative to emit a beam of essentially monochromatic light of a preselected wavelength, wherein the preselected wavelengths of light emitted by the members of said plurality of light emitters differ from one another so as to define a preselected wavelength range;
a support for retaining a layer of a material so that it will be illuminated by the beams of essentially monochromatic light emitted by the plurality of light emitters;
a controller for sequentially energizing the members of the plurality of light emitters so as to cause them to sequentially illuminate the layer with a time-variant series of incident beams of differing wavelengths of essentially monochromatic light, whereby said incident beams are reflected from said layers so as to produce a time-variant series of reflected beams;
a light detector disposed and operative to sense light reflected from said layer, said detector being operative to sense said time-variant series of reflected beams and generate a signal corresponding thereto;
a processor operative to receive said signal from said detector and generate a waveform corresponding to the reflectance of light from said layer as a function of the wavelengths of light in said preselected wavelength range, said processor being further operative to process said waveform so as to determine the thickness of said layer.

15. The apparatus of claim 14, wherein said light emitters comprise light emitting diodes.

16. The apparatus of claim 15, wherein said light emitting diodes are disposed in said light source so that when a layer of material is disposed in said support, said light emitting diodes are all equally spaced therefrom.

17. The apparatus of claim 14, wherein said plurality of light emitters comprises at least ten light emitters.

18. The apparatus of claim 14, wherein said plurality of light emitters comprises at least twenty light emitters.

19. The apparatus of claim 14, wherein said wavelength range is 400-900 nanometers.

20. The apparatus of claim 14, wherein said processor employs a Levenberg-Marquardt algorithm to determine said waveform.

21. A reverse interferometric method for determining the thickness of a layer of a material, said method comprising:
providing a multi-wavelength light source, said light source including a plurality of light emitters, each light emitter being operative to emit a beam of essentially monochromatic light of a preselected wavelength, wherein the preselected wavelengths of light emitted by the members of said plurality of light emitters differ from one another so as to define a preselected wavelength range;
disposing a layer of a material so that it will be illuminated by the beams of essentially monochromatic light emitted by the plurality of light emitters;
energizing the members of the plurality of light emitters so as to illuminate the layer with a series of incident beams of differing wavelengths of essentially monochromatic light, whereby said incident beams are reflected from said layer so as to produce a time-variant series of reflected beams;
disposing a light detector so as to sense light reflected from said layer;
activating said detector so as to sense said series of reflected beams and generate a signal corresponding thereto;
processing said signal so as to generate a waveform corresponding to the reflectance of light from said layer as a function of the wavelengths of light in said preselected wavelength range; and
processing said waveform so as to determine the thickness of said layer.

22. A reverse interferometric apparatus for determining the thickness of a layer of a material, said apparatus comprising:
a multi-wavelength light source including a plurality of light emitters, each light emitter being operative to emit a beam of essentially monochromatic light of a preselected wavelength, wherein the preselected wavelengths of light emitted by the members of said plurality of light emitters differ from one another so as to define a preselected wavelength range;
a support for retaining a layer of a material so that it will be illuminated by the beams of essentially monochromatic light emitted by the plurality of light emitters;
a controller for energizing the members of the plurality of light emitters so as to cause them to illuminate the layer with a series of incident beams of differing wavelengths of essentially monochromatic light, whereby said incident beams are reflected from said layers so as to produce a series of reflected beams;
a light detector disposed and operative to sense light reflected from said layer, said detector being operative to sense said series of reflected beams and generate a signal corresponding thereto;
a processor operative to receive said signal from said detector and generate a waveform corresponding to the reflectance of light from said layer as a function of the wavelengths of light in said preselected wavelength range, said processor being further operative to process said waveform so as to determine the thickness of said layer.
